(19) United States
(12) Patent Application Publication
(10) Pub. No.: US 2009/0252649 A1
(43) Pub. Date: Oct. 8, 2009

(54) Apparatus for body fluid analysis using surface-textured optical materials

(76) Inventor: Hiroshi Nomura, Shorewood, MN (US)

Correspondence Address: CYR & ASSOCIATES, P.A., 605 U.S. Highway 169, Suite 300, Plymouth, MN, 55441, US

(21) Appl. No.: 12/215,055

(22) Filed: Jun. 25, 2008

Related U.S. Application Data
(62) Division of application No. 10/979,776, filed on Nov. 1, 2004, now abandoned.
(60) Provisional application No. 60/516,656, filed on Oct. 31, 2003.
(60) Provisional application No. 60/516,654, filed on Oct. 31, 2003.
(60) Provisional application No. 60/516,655, filed on Oct. 31, 2003.

(51) Int. Cl. G01N 21/76; G01N 21/00; G01N 31/22; G01N 21/64

(52) U.S. Cl. 422/52; 422/82.11; 422/56; 422/82.08; 422/82.09

(57) ABSTRACT

A variety of characteristics of body fluid may be measured by introducing a sample to a textured surface on optical material such as waveguides and sheets. The textured surface presents a field of elongated projections which are spaced apart to exclude certain components of the body fluid sample from entering into the spaces between the projections, while permitting other parts of the body fluid sample which contains the analyte to enter into those spaces. The analyte contacts a chemistry on the surface which is sensitive to the analyte, whereupon the analyte and the analyte-sensitive chemistry interact in a manner that is optically detectable. The optical material is packaged in suitable structures such as elongated cylinders, flat test strips, and sheets. A structure containing the optical material is mounted on a detector, which both illuminates the optical material and detects and analyzes the light that returns from the textured surface.

### CROSS-REFERENCE TO RELATED APPLICATIONS

This patent is a divisional of and claims the benefit of prior U.S. patent application Ser. No. 10/979,776, filed Nov. 1, 2004, (Nomura, “System and Apparatus for Body Fluid Analysis Using Surface Textured Optical Materials”), which claims the benefit of U.S. Provisional Patent Application Ser. No. 60/516,656 filed Oct. 31, 2003 (Nomura, “Method and Apparatus for Body Fluid Analysis Using Surface-Textured Optical Materials”), U.S. Provisional Patent Application Ser. No. 60/516,654 filed Oct. 31, 2003 (Nomura, “Plasma Polymerization of Atomically Modified Surfaces”), and U.S. Provisional Patent Application Ser. No. 60/516,655 filed Oct. 31, 2003 (Shebuski et al., “Detection of Acute Myocardial Infarction Precursors”), all of which hereby are incorporated herein in their entirety by reference thereto.

### BACKGROUND OF THE INVENTION

1. Field of the Invention

The present invention relates to body fluid analysis, and more particularly to methods and apparatus for body fluid analysis using surface-textured optical materials.

2. Description of Related Art

A minimally invasive sensing element that utilizes a light-conducting fiber having a localized textured site thereon and methods for its use are described in U.S. Pat. No. 5,859,937, which issued Jan. 12, 1999, to Nomura. The textured surface is formed either by ion beam sputtering or by atomic oxygen etching. A reagent specific for a particular analyte is deposited on the localized textured site, and an interaction of the reagent with the analyte produces a response that is detectable by a change in characteristics of a light beam transmittable through the fiber. What is desired is improved methods and apparatus using the sensing element for body fluid analysis.

### BRIEF SUMMARY OF THE INVENTION

Advantageously, the present invention is suitable for use in a variety of settings. Illustratively, some embodiments are particularly suitable for home use, others for medical office and clinical use, others for emergency room use, others for laboratory use, and yet others for multiple uses. Each assay of body fluid may be performed with a very small amount of the body fluid and at a much greater speed, relative to approaches that are based on membrane and wet chemistry technologies.

Some embodiments of the present invention may be used in a central laboratory of a hospital to advantageously eliminate several critical problems. The time it takes to send blood specimens and receive test results is eliminated, and various central laboratory preparation procedures that could alter the specimen or introduce errors are eliminated.

Some embodiments of the present invention allow testing to take place in emergency rooms, specialized sites such as oncology clinics, intensive care units, and in small clinics or offices outside of metropolitan medical centers. It brings the testing to the patient-physician interface at the time of maximal usefulness. In critical situations the quick specific test information can lead to prompt treatment or other diagnostic procedures.

Some embodiments of the present invention are particularly useful for self-testing in the home or individual testing in the physician's office. Embodiments for home use are simple to use, and some are very inexpensive to make.

These and other advantages are individually or collectively realized by the various embodiments of the present invention, one embodiment of which is a sensor element for measuring characteristics of a body fluid, comprising a supporting body; an optical material body having a surface-textured area with an analyte-specific chemistry disposed thereon and a light introduction area, the optical material body being supported by the supporting body; a body fluid sample receiving area, the surface-textured area being presented into the body fluid receiving area; and a light coupling area, the light introduction area being presented at the light coupling area. The optical material body may be a waveguide, including a solid optical fiber, or an optical material sheet.

A further embodiment of the present invention is a sensor element for use in measuring characteristics of a body fluid, comprising a supporting body; an optical material body supported by the supporting body and having a surface-textured area and a light transit area; an analyte-sensitive chemistry disposed upon the surface-textured area, the analyte-sensitive chemistry having at least one optical property sensitive to binding of an analyte thereto; a body fluid sample receiving area, the surface-textured area being presented into the body fluid receiving area; and a light coupling area, the light transit area of the optical material body being presented at the light coupling area. The surface-textured area comprises a field of projecting elongated optical structures providing an increased effective sensing area and supporting multiple ray reflections responsive to the optical property of the analyte-sensitive chemistry.

A further embodiment of the present invention is a sensor array for use in measuring characteristics of body fluids, comprising a plurality of surface-textured areas, each of the surface-textured areas being treated with an analyte-sensitive chemistry having at least one optical property sensitive to binding of an analyte thereto; an array of body fluid sample receiving areas, the surface-textured areas respectively being presented into the body fluid receiving areas; and an optical interrogation region for optically interrogating each of the surface-textured areas. Each of the surface-textured areas comprises a field of projecting elongated optical structures providing an increased effective sensing area and supporting multiple ray reflections responsive to the optical properties of the analyte-sensitive chemistry.

A further embodiment of the present invention is a sensor for use in measuring characteristics of body fluids, comprising a plurality of surface-textured areas, each of the surface-textured areas being treated with an analyte-sensitive chemistry having a at least one optical property sensitive to binding of an analyte thereto; a body fluid sample receiving area, the surface-textured areas respectively being presented into the body fluid receiving area; and an optical interrogation region for optically interrogating each of the surface-textured areas. Each of the surface-textured areas comprises a field of projecting elongated optical structures providing an increased effective sensing area and supporting multiple ray reflections responsive to the optical property of the analyte-sensitive chemistry.

A further embodiment of the present invention is a sensor for use in measuring a characteristic of body fluid, comprising a sheet of optical material having first and second opposing major surfaces; a surface-textured area formed in the first major surface of the sheet and treated with an analyte-sensitive chemistry having at least one optical property sensitive to binding of an analyte thereto; and a light transit area formed in the second major surface of the sheet opposing the surface-textured area. The surface-textured area comprises a field of projecting elongated optical structures providing an increased effective sensing area and supporting multiple ray reflections responsive to the optical property of the analyte-sensitive chemistry.

A further embodiment of the present invention is a system for measuring a characteristic of body fluid, comprising a sensor section having a surface-textured area comprising a field of projecting elongated optical structures with an analyte-sensitive chemistry disposed thereupon, the analyte-sensitive chemistry having at least one optical property sensitive to binding of an analyte thereto, and the elongated optical structures of the surface-textured area providing an increased effective sensing area and supporting multiple ray reflections responsive to the optical property of the analyte-sensitive chemistry; and a detector section, the sensor section being mounted on the detector section. The detector section comprises a light illumination subsystem optically coupled to the surface-textured area; and a light detection subsystem optically coupled to the surface-textured area for detecting returned light from illumination of the surface-textured areas.

A further embodiment of the present invention is a system for measuring a characteristic of body fluid, comprising a sensor section having a plurality of surface-textured areas comprising respective fields of projecting elongated optical structures with analyte-sensitive chemistries disposed thereupon, the analyte-sensitive chemistries having optical properties sensitive to binding of analytes thereto, and the elongated optical structures providing an increased effective sensing area and supporting multiple ray reflections responsive to optical properties of the analyte-sensitive chemistries; and a detector section, the sensor section being mounted on the detector section. The detector section comprises a light illumination subsystem optically coupled to the surface-textured areas; a light collection subsystem optically coupled to the surface-textured areas for collecting returned light from the surface-textured areas; and a light detector optically coupled to the light collection subsystem and responsive to the returned light for respectively detecting the light-influencing properties.

A further embodiment of the present invention is a system for measuring a characteristic of body fluid, comprising a waveguide having a surface-textured area disposed thereupon and an optical window disposed thereupon in optical proximity to the surface-textured area. The surface-textured area comprises a field of projecting elongated optical structures with an analyte-sensitive chemistry disposed thereupon. The analyte-sensitive chemistry has at least one optical property sensitive to binding of an analyte thereto, and the elongated optical structures provide an increased effective sensing area and supporting multiple ray reflections responsive to the optical property of the analyte-sensitive chemistry. A light source is optically coupled to one end of the waveguide; and a detector section is optically coupled to the optical window.

### BRIEF DESCRIPTION OF THE SEVERAL VIEWS OF THE DRAWINGS

FIG. 1 is a schematic diagram of a principle of operation of certain embodiments of the invention.

FIG. 2 is a schematic diagram of a medical instrument suitable for personal use in measuring one body fluid characteristic.

FIG. 3 is a schematic diagram of a medical instrument suitable for personal use in measuring multiple body fluid characteristics.

FIG. 4 is a schematic diagram of a medical instrument suitable for use in a rapid response setting to measure multiple critical body fluid characteristics.

FIG. 5 is a schematic diagram of a medical instrument suitable for use in a laboratory or diagnostic testing setting to measure many body fluid characteristics of many patients.

FIG. 6 is a pictorial view of an SEM image of a textured surface.

FIG. 7 is a cross sectional view along the longitudinal axis of a sensor element that incorporates an optical fiber having a textured surface at the tip.

FIG. 8 is a cross sectional view along the longitudinal axis of another sensor element that incorporates an optical fiber having a textured surface at the tip.

FIG. 9 is a cross sectional view along the longitudinal axis of another sensor element that incorporates an optical fiber having a textured surface at the tip.

FIG. 10 is a cross sectional view normal to the longitudinal axis of the sensor element of FIG. 9.

FIG. 11 is a cross sectional view along the longitudinal axis of another sensor element that incorporates an optical fiber having a textured surface at the distal periphery thereof, including the tip and sidewall area adjacent to the tip.

FIG. 12 is a cross sectional view along the longitudinal axis of another sensor element that incorporates three optical fibers having textured surfaces at the tips thereof.

FIG. 13 is a cross sectional view along the longitudinal axis of another sensor element that incorporates an optical fiber having two textured surfaces at the distal periphery thereof, including the tip and a sidewall area spaced away from the tip.

FIG. 14 is a cross sectional view along the longitudinal axis of another sensor element that incorporates two optical fibers having textured surfaces at the tips thereof.

FIG. 15 is a perspective view of an assay strip that incorporates an optical fiber.

FIG. 16 is a perspective view of another assay strip that incorporates an optical fiber.

FIG. 17 is a perspective view of another assay strip that incorporates an optical fiber.

FIG. 18 is a perspective view of another assay strip that incorporates an optical fiber.

FIG. 19 is a cross section of part of a sheet of optical material having one type of analyte-specific chemistry upon a textured surface thereof.

FIG. 20 is a cross section of part of a sheet of optical material having two types of analyte-specific chemistry upon a textured surface thereof.

FIG. 21 is a cross section of part of a sheet of optical material having two types of analyte-specific chemistries upon respective textured surfaces that are separated by a divider.

FIG. 22 is a cross section of part of a sheet of optical material having two types of analyte-specific chemistries upon respective textured surfaces that are separated by a divider and situated within a body fluid receiving well.

FIG. 23 is a top plan view of a circular sheet of optical material that has four measurement sites.

FIG. 24 is a perspective view of an assay strip that incorporates a surface textured optical sheet.

FIG. 25 is a top plan view of the assay strip of FIG. 24.

FIG. 26 is a longitudinal cross sectional view of the assay strip of FIG. 24.

FIG. 27 is a side plan view of a sheet of optical material having curved waveguides therein.

FIG. 28 is a top plan view of the sheet of optical material of FIG. 27.

FIG. 29 is a schematic diagram of an optical system for illuminating and receiving light from a measurement site.

FIG. 30 is a schematic diagram showing illumination of a measurement site.

FIG. 31 is a schematic diagram showing receiving light from a measurement site.

FIG. 32 is a schematic diagram of an optical system for illuminating and receiving light from multiple measurement sites.

FIG. 33 is a schematic diagram of another optical system for illuminating and receiving light from a single measurement site.

FIG. 34 is a schematic diagram of another optical system for illuminating and receiving light from a single measurement site.

FIG. 35 is a schematic diagram of another optical system for illuminating and receiving light from multiple measurement sites.

FIG. 36 is a schematic diagram of another optical system for illuminating and receiving light from multiple measurement sites.

FIG. 37 is a schematic diagram of a optical system for illuminating and receiving light from a waveguide containing a measurement site.

FIG. 38 is a schematic diagram of another optical system for illuminating and receiving light from a waveguide containing a measurement site.

FIG. 39 is a cross sectional view of a slot and optical components for receiving and reading a single site assay strip.

FIG. 40 is a cross sectional view of a slot and optical components for receiving and reading a multiple site assay strip.

FIG. 41 is a graph showing the spectroscopic response of an optic fiber pH sensor without surface texturing.

FIG. 42 is a graph showing the spectroscopic response of an optic fiber pH sensor with a degree of surface texturing.

FIG. 43 is a graph showing the spectroscopic response of an optic fiber pH sensor with a different degree of surface texturing.

FIG. 44 is a graph showing the spectroscopic response of an optic fiber pH sensor with yet a different degree of surface texturing.

### DETAILED DESCRIPTION OF THE INVENTION, INCLUDING THE BEST MODE

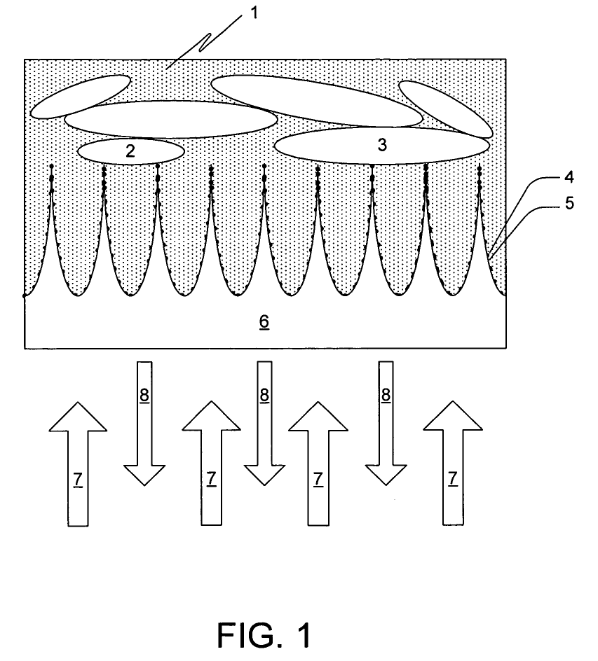

A variety of useful characteristics of a body fluid such as blood or urine may be measured by introducing a sample of the blood to a textured surface of an optical material. FIG. 1 is a schematic diagram showing in greatly simplified form the basic principle of operation of assay instruments for body fluid analysis using a surface-textured optical material. A body fluid sample 1 rests on the surface 4 of optical material 6. The surface 4 is suitably textured so that it presents a field of elongated projections. The projections are suitably spaced apart to exclude certain cellular components such as cells 2 and 3 of the body fluid sample 1 from entering into the spaces between the projections, while permitting the remaining part of the body fluid sample 1, which contains the analyte, to enter into those spaces. The analyte contacts a chemistry on the surface 4 which is sensitive to the analyte, whereupon the analyte and the analyte-sensitive chemistry interact in a manner that is optically detectable. Preferably the analyte-sensitive chemistry is an analyte specific chemistry 5. Suitable analyte-specific chemistries include receptor molecules as well as reactive molecules. The nature and arrangement of the analyte-specific chemistry 5 varies depending on the application; for example, the analyte-specific chemistry 5 may be a layer of one type of chemistry or an ordered array or a finely mixed composite of different types of analyte-specific chemistries. Incident light 7, which may be light in the visible, ultraviolet or infrared ranges, is shown as normal to the optical material 6, but may fall upon the optical material 6 at other angles. The incident light 7 interacts with the analyte-specific chemistry 5, and resulting light 8, which is shown as normal to the optical material 6 but which may leave the optical material 6 at other angles, is detected. A measurable property of the resulting light 8 is affected by the change in the property of the analyte-specific chemistry 5, and this altered property of the resulting light 8 is detected. During the measurement process, the optical material 6 should be shielded from ambient light in any suitable way (not shown). Examples of suitable optical detection principles include absorbance determination of the analyte reflectance colorimetric determination of the analyte, reflectance scattering determination of the analyte, fluorescence determination of the analyte, and chemiluminescence determination (incident light not required) of the analyte. A variety of other suitable optical detection techniques are well known in the art, and additional suitable techniques will be developed in the future. Examples of measurable blood characteristics include blood glucose and cardiovascular markers, as well as other diagnostic testing. Illustrative cardiovascular markers for ruling out acute myocardial infarction, for example, include platelet activation markers, pro-coagulation markers, pro-inflammatory markers, and cardiac and specialty markers. The close proximity of the analyte-specific chemistry to the introduced body fluid sample advantageously permits the measurement to be performed very quickly using only a very small amount of blood, relative to various membrane strip technologies in common use.

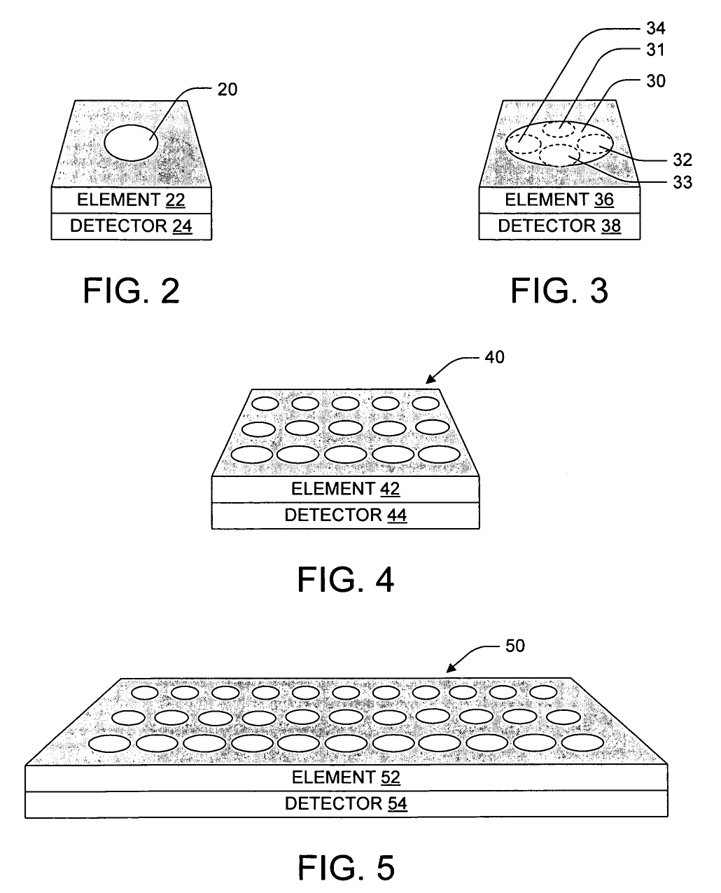

Instruments for body fluid analysis using a surface-textured optical material are suitable for use in a wide variety of applications. Some embodiments are particularly suitable for home use, others for medical office and clinical use, others for emergency room use, others for laboratory use, and yet others for multiple uses. FIG. 2 through FIG. 5 are schematic diagrams of various illustrative types of instruments for body fluid analysis using a surface-textured optical material. The blocks in these figures show the interrelationships between the elements, and are not intended to suggest any particular shape or composition of the elements themselves. FIG. 2 shows an illustrative instrument for use at home or in a physician's office to measure a single characteristic of a body fluid, such as may be used by a diabetic for monitoring blood glucose levels. In the case of blood, the projections of the surface-textured optical material excludes cells such as the red blood cells from the optically interrogated volume, since these cells have much optical activity that would interfere with the measurement. A sensor element 22 is mounted on detector 24. A sample receiving area 20 in the sensor element 22 has a textured surface area that is treated to include a suitable analyte-specific chemistry. FIG. 3 shows an illustrative instrument for use at home or in a physician's office to measure several characteristics of a body fluid, such as may be used by person at high risk for heart attack for monitoring glucose levels, total and HDL cholesterol, and various cardiac markers from a single body fluid sample. A sensor element 36 is mounted on detector 38. A sample receiving area 30 in the sensor element 36 has four textured surface areas treated with different analyte-specific chemistry; for example, area 31 may be treated to measure glucose, area 32 may be treated to measure total cholesterol, area 33 may be treated to measure HDL cholesterol, and area 34 may be treated to measure a cardiac marker. Generally speaking, the assay instruments of FIG. 2 and FIG. 3 are particularly suitable for the personal testing, including self-testing, for blood glucose, cholesterol, lipids (LDL can be measured directly) or other components of the blood including antigens, antibodies, enzymes, tumor markers, coagulation and fibrinolytic components, infectious disease markers, and others.

FIG. 4 shows an illustrative instrument which may be used in a rapid response setting such as an emergency room or onboard an ambulance or medical helicopter to measure many characteristics of a body fluid needed to treat a trauma victim, or in specialized sites such as oncology clinics, intensive care units, small clinics or offices outside of metropolitan medical centers. A sensor element 42 is mounted on detector 44. The sensor element 42 has an array 40 of textured surface areas treated with a variety of different analyte-specific chemistries. Generally in the emergency room, a disposable sensor or an array of fiber sensors may be used to rapidly carry out a number of critical screening tests—from routine to complex measurements—such as the platelet activation and pro-coagulation and pro-inflammatory markers as well as cardiac enzymes such as Troponin I.

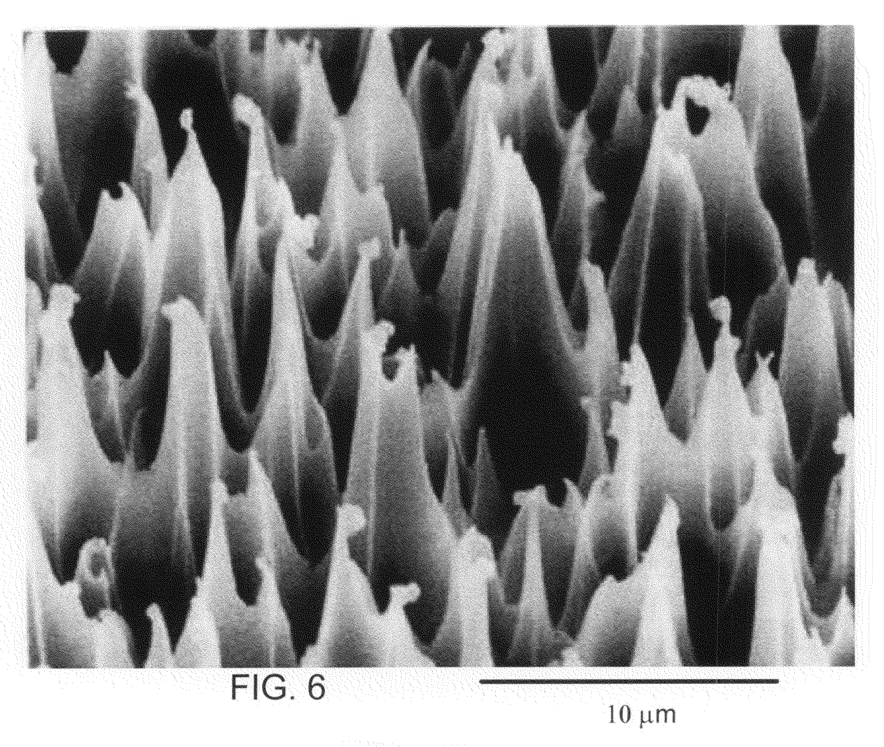

FIG. 5 shows an illustrative instrument for use by laboratory personnel in a large scale operation such as a medical diagnostic testing laboratory to measure a great many different characteristics of a body fluid for a great many patients. A sensor element 52 is mounted on detector 54. The sensor element 52 has a very large array 50 of textured surface areas treated with analyte-specific chemistries. The choice of which analyte-specific chemistries to use in the textured surface areas depends on how the sensor element 52 is to be used; for example, the sensor element 52 may be used to carry out a common suite of tests on a number of patients, in which case groups of the textured surface areas in the array are treated with respective analyte-specific chemistries needed for the tests in the suite.

Advantageously, instruments such as those shown in FIG. 2 through FIG. 5 use a dry assay chemistry that is self-contained within the instrument. A great many different types of assays can be carried out for a wide variety of analytes. Assays that can be performed include, but are not limited to, general chemistry assays and immunoassays. Both endpoint and reaction rate type assays can be accomplished.

The term “analyte” is used to refer to the substance to be detected in the test sample. For example, general chemistry assays can be performed for analytes such as, but not limited to, glucose, cholesterol, HDL cholesterol, LDL cholesterol, triglycerides, and BUN. For immunoassays, the analyte can be any substance for which there exists a naturally occurring specific binding member (such as, an antibody), or for which a specific binding member can be prepared. An analyte may also be any antigenic substances, haptens, antibodies, macromolecules, and combinations thereof. As a member of a specific binding pair, the analyte can be detected by means of naturally occurring specific binding partners (pairs) such as the use of intrinsic factor protein as a member of a specific binding pair for the determination of Vitamin B12, or the use of lectin as a member of a specific binding pair for the determination of a carbohydrate. The analyte can include a protein, a peptide, an amino acid, a hormone, a steroid, a vitamin, a drug, a bacterium, a virus, and metabolites of or antibodies to any of the above substances. Illustrative analytes include, but are not limited to, ferritin; creatinine kinase MB (CK-MB); digoxin; phenytoin; phenobarbital; carbamazepine; vancomycin; gentamicin, theophylline; valproic acid; quinidine; luteinizing hormone (LH); follicle stimulating hormone (FSH); estradiol, progesterone; IgE antibodies; Vitamin B2 micro-globulin; glycated hemoglobin (Gly Hb); cortisol; digitoxin; N-acetylprocainamide (NAPA); procainamide; antibodies to rubella, such as rubella-IgG and rubella-IgM; antibodies to toxoplasma, such as toxoplasmosis IgG (Toxo-IgG) and toxoplasmosis IgM (Toxo-IgM); testosterone; salicylates; acetaminophen; hepatitis B core antigen, such as anti-hepatitis B core antigen IgG and IgM (Anti-HBC); human immune deficiency virus 1 and 2 (HIV 1 and 2); human T-cell leukemia virus 1 and 2 (HTLV); hepatitis B antigen (HBAg); antibodies to hepatitis B antigen (Anti-HB); thyroid stimulating hormone (TSH); thyroxine (T4); total triiodothyronine (Total T3); free triiodothyronine (Free T3); carcinoembryonic antigen (CEA); and alpha fetal protein (AFP). Drugs of abuse and controlled substances include, but are not limited to, amphetamine; methamphetamine; barbiturates such as amobarbital, secobarbital, pentobarbital, phenobarbital, and barbital; benzodiazepines such as librium and valium; cannabinoids such as hashish and marijuana; cocaine; fentanyl; LSD; methaqualone; opiates such as heroin, morphine, codeine, hydromorphone, hydrocodone, methadone, oxycodone, oxymorphone, and opium; phencyclidine; and propoxyphene. The details for the preparation of such antibodies and their suitability for use as specific binding members are well known to those skilled in the art.

The assays contemplated herein preferably use members of a specific binding pair, wherein one of the molecules through chemical or physical means specifically binds to the other molecule. Therefore, in addition to antigen and antibody specific binding pairs of common immunoassays, other specific binding pairs can include biotin and avidin, carbohydrates and lectins, complementary nucleotide sequences, effector and receptor molecules, cofactors and enzymes, enzyme inhibitors and enzymes, and the like. Furthermore, specific binding pairs can include members that are analogs of the original specific binding members, for example, an analyte-analog. Immunoreactive specific binding members include antigens, antigen fragments, antibodies, and antibody fragments, both monoclonal and polyclonal, and complexes thereof, including those formed by recombinant DNA molecules. The term hapten, as used herein, refers to a partial antigen or non-protein binding member which is capable of binding to an antibody, but which is not capable of eliciting antibody formation unless coupled to a carrier protein.

The analyte-analog can be any substance which cross-reacts with the analyte-specific binding member, although it may do so to a greater or lesser extent than does the analyte itself. The analyte-analog can include a modified analyte as well as a fragmented or synthetic portion of the analyte molecule, so long as the analyte-analog has at least one epitope site in common with the analyte of interest. An example of an analyte-analog is a synthetic peptide sequence which duplicates at least one epitope of the whole-molecule analyte so that the analyte-analog can bind to an analyte-specific binding member.

The body fluid sample may be derived from any biological source, such as a physiological fluid, including whole blood or whole blood components including red blood cells, white blood cells, platelets, serum and plasma; ascites; urine; sweat; milk; synovial fluid; peritoneal fluid; amniotic fluid; cerebrospinal fluid; and other constituents of the body which may contain the analyte of interest. The sample may be pre-treated prior to use for some assays, but preferably is not pre-treated in instruments intended for use by the patient.

In the instruments of FIG. 2 through FIG. 5, the sensor elements 22, 36, 42 and 52 preferably are disposable, while the detectors 24, 38, 44 and 54 preferably are reusable. However, the various parts of these instruments may be made disposable or non-disposable as desired. Both the sensor element and detector of an instrument may be made disposable, in which case the entire instrument may be discarded after use. Alternatively, both the sensor element and the detector of an instrument may non-disposable so that they may, in limited circumstances, be reused after suitable cleaned and sterilization.

While the textured surface areas of the sensor elements 22, 36, 42 and 52 in FIG. 2 through FIG. 5 are shown as circular, any desired shape may be used.

The Sensor Element

Many different types of optical material may be surface-textured for use in the measurement of characteristics of a body fluid. One type of suitable optical material is the optical fiber. A minimally invasive sensing device that uses a light conducting fiber having a localized textured site thereon and methods for its manufacture and use are described in U.S. Pat. No. 5,859,937, which issued Jan. 12, 1999, to Nomura, and which is incorporated herein in its entirety by reference thereto. Optical fibers may be fabricated from a variety of polymers such as PMMA, polycarbonate, polystyrenes, polysulfones, polymamide, polyvinylchloride (“PVC”) and polyimide, and from other types of optical materials such as glass, plastic, glass/glass composite and glass/plastic composite fiber waveguides. Optical fibers typically although not necessarily are provided with a cladding to support the fiber and assist in guiding light along the fiber. Prior to texturing, the fiber tip is given a desired geometric shape, which is dependent on the application and performance requirements, and which include planar surfaces either normal with respect to or otherwise angled with respect to the fiber axis, convex and concave conical surfaces, and convex and concave semi-spherical surfaces. A number of novel minimally invasive sensing devices that also use one or more light conducting fibers are described below.

A textured surface may be provided on a variety of optical materials other than fibers. Another type of sensor element is made from a sheet of transparent optical material such as, for example, plastic or polymers (including polycarbonate and polyimide), glass, and quartz glass. If sample receiving areas are desired in the sheet, they may be formed by any of various process depending on the type of optical material. Where the material is quartz, for example, the sample areas may be etched using dry or wet etch processes. Where the material is a molded plastic, the mold may contain certain surface recesses and protrusions for forming the sample areas. The sheets may include other optical components such as lenses. Multiple sensor elements may be made from each sheet by dicing, laser cutting, stamping, or otherwise dividing the sheet. Individual sensor elements or entire sheets or parts of sheets may be incorporated into a variety of sensing instruments having a diversity of different applications, as also described below.

While various surface texturing processes are available, polymer or plastic optical materials preferably are textured by etching with atomic oxygen. Generation of atomic oxygen can be accomplished by several known methods, including radio frequency, microwave, and direct current discharges through oxygen or mixtures of oxygen with other gases. Directed beams of oxygen such as by an electron resonance plasma beam source may also be utilized, accordingly as disclosed in U.S. Pat. No. 5,560,781, issued Oct. 1, 1996 to Banks et al., which is incorporated herein in its entirety by reference thereto. Techniques for surface texturing are described in U.S. Pat. No. 5,859,937, which issued Jan. 12, 1999, to Nomura, and which is incorporated herein in its entirety by reference thereto.

Atomic oxygen can be used to microscopically alter the surface topography of polymeric materials in space or in ground laboratory facilities. For polymeric materials whose sole oxidation products are volatile species, directed atomic oxygen reactions produce surfaces of microscopic cones. However, isotropic atomic oxygen exposure results in polymer surfaces covered with lower aspect ratio sharp-edged craters. Isotropic atomic oxygen plasma exposure of polymers typically causes a significant decrease in water contact angle as well as altered coefficient of static friction. Atomic oxygen texturing of polymers is further disclosed and the results of atomic oxygen plasma exposure of thirty-three (33) different polymers, including typical morphology changes, effects on water contact angle, and coefficient of static friction, are presented in Banks et al., Atomic Oxygen Textured Polymers, NASA Technical Memorandum 0.106769, Prepared for the 1995 Spring Meeting of the Materials Research Society, San Francisco, Calif., Apr. 17-21, 1995, which hereby is incorporated herein in its entirety by reference thereto.

An illustrative SEM image of a textured surface as reported in the NASA Technical Memorandum is shown in FIG. 6, which shows a high aspect ratio cone-like surface morphology resulting from high fluence directed atomic oxygen exposure in space for chlorotrifluoroethylene exposed to directed atomic oxygen on the Long Duration Exposure Facility. The diameter of the cones is roughly 1 μm, the depth is roughly 5 μm, and the spacing between cones is roughly 5 μm. These dimensions are well suited for separating red blood cells from whole blood, since red blood cells tend to be of a diameter of roughly 8 μm.

The general shape of the projections in any particular field is dependent upon the particulars of the method used to form them and on subsequent treatments applied to them. Suitable shapes include conical, ridge-like, pillared, box-like, and spike-like. While the projections may be arrayed in a uniform or ordered manner or may be randomly distributed, the distribution of the spacings between the projections preferably is fairly narrow with the average spacing being such as to exclude certain cellular components of blood such as the red blood cells from moving into the space between the projections. The projections function to separate blood components so that the analyte that reacts with the surface-resident agent is free of certain undesirable body fluid components. In some applications such as the ruling out of acute myocardial infarction using platelet activation markers, the spacings between the projections generally should be great enough to admit the platelets while excluding the red blood cells.

The textured surface preferably is treated after formation by plasma polymerization to modify the surface of materials and to achieve specific functionality. Surfaces may be made wet-able, non-fouling, slippery, highly cross-linked, reactive, reactable or catalytic. The precisely controlled plasma process is a chemical bonding technology by which high-energy plasma is created at near ambient temperatures in a vacuum, causing a gaseous monomer (or polymer) to chemically modify the surface of a substrate material. Preferably, the plasma polymer deposition does not significantly change the textured structure, but does increase the dye binding capacity for carboxyl (COOH) groups.

As an example of a method of making an atomic oxygen textured substrate for use in genomic, immunoassay, or cardiac marker sensing in accordance with the present invention, one or more specimens of atomic oxygen textured substrates are introduced into a chamber evacuated to less than 1.0 torr, preferably to about 30 millitorr or less. Then, a monomer vapor is introduced into the vacuum chamber, and a glow discharge is initiated. The nature of the gas plasma is controlled according to the composite plasma parameter W/FM where W is the power input, F is the flow rate of the monomer vapor, and M is the molecular weight of the particular monomer selected for plasma polymerization. In addition to this parameter and to monomer selection, exposure time of the specimen to the gas plasma is preferably also controlled. Additional control may be exercised by generating an intermittent glow discharge such that plasma polymerizate deposited on a specimen's surface may have time to interact with monomer vapor in the absence of glow discharge, whereby some grafting of monomer may be effected. Additionally, the resulting plasma polymerizate may be exposed to unreacted monomer vapor in the absence of a glow discharge as a post-deposition treatment, whereby residual free radicals may be quenched.

Polymerizable monomers that may be used may comprise unsaturated organic compounds such as halogenated olefins, olefinic carboxylic acids and carboxylates, olefinic nitrile compounds, olefinic amines, oxygenated olefins and olefinic hydrocarbons. Such olefins include vinylic and allylic forms. The monomer need not be olefinic, however, to be polymerizable. Cyclic compounds such as cyclohexane, cyclopentane and cyclopropane are commonly polymerizable in gas plasmas by glow discharge methods. Derivatives of these cyclic compounds, such as 1,2-diaminocyclohexane for instance, are also commonly polymerizable in gas plasmas. Particularly preferred are polymerizable monomers containing hydroxyl, amino or carboxylic acid groups. Of these, particularly advantageous results have been obtained through use of allylamine or acrylic acid. Mixtures of polymerizable monomers may be used. Additionally, polymerizable monomers may be blended with other gases not generally considered as polymerizable in themselves, examples being argon, nitrogen and hydrogen. The polymerizable monomers are preferably introduced into the vacuum chamber in the form of a vapor. Polymerizable monomers having vapor pressures of at least 0.05 torr at ambient room temperature are preferred. Where monomer grafting to plasma polymerizate deposits is employed, polymerizable monomers having vapor pressures of at least 1.0 torr at ambient conditions are particularly preferred.

The gas plasma pressure in the vacuum chamber 12 may vary in the range of from 0.01 torr to 2.0 torr. Gas plasma pressures are preferably in the range of 0.05 to 1.0 torr for best results. The glow discharge through the gas or blend of gases in the vacuum chamber may be initiated by means of an audio frequency, a microwave frequency or a radio frequency field transmitted to or through a zone in the vacuum chamber 12. A 50 kHz frequency may be used; however, in commercial scale usage of RF plasma polymerization, an assigned radio frequency of 13.56 MHz may be desirable to avoid potential radio interference problems. The plasma treatment process is described in greater detail in a United States patent application filed concurrently herewith entitled “Plasma Polymerization of Atomically Modified Surfaces” which names Hiroshi Nomura as inventor and bears Attorney Docket No. 1875-004, and which is incorporated herein in its entirety by reference thereto.

The bonding member for the analyte is attached to the plasma-deposited polymeric surface in a manner that varies depending on the bonding partner. For blood glucose determinations, for example, the binding partner may be a composition including a peroxidase enzyme and color-generating chemical couplers. Many other chemical systems for blood glucose determinations are disclosed in U.S. Pat. No. 4,935,346, issued Jun. 19, 1990 to Phillips et al., which hereby is incorporated herein in its entirety by reference thereto. For antigens, antibodies, enzymes, enzyme inhibitors, and various other biochemical agents, attachment of affinity ligands to the polymeric surface through covalent bonding may be practiced. The attachment of various cardiovascular markers may also be practiced, as described in greater detail in a United States patent application filed concurrently herewith entitled “Detection of Acute Myocardial Infarction Biomarkers” which names Ronald J. Shebuski, Arthur R. Kydd, and Hiroshi Nomura as inventors and bears Attorney Docket No. 1875-003, and which hereby is incorporated herein in its entirety by reference thereto.

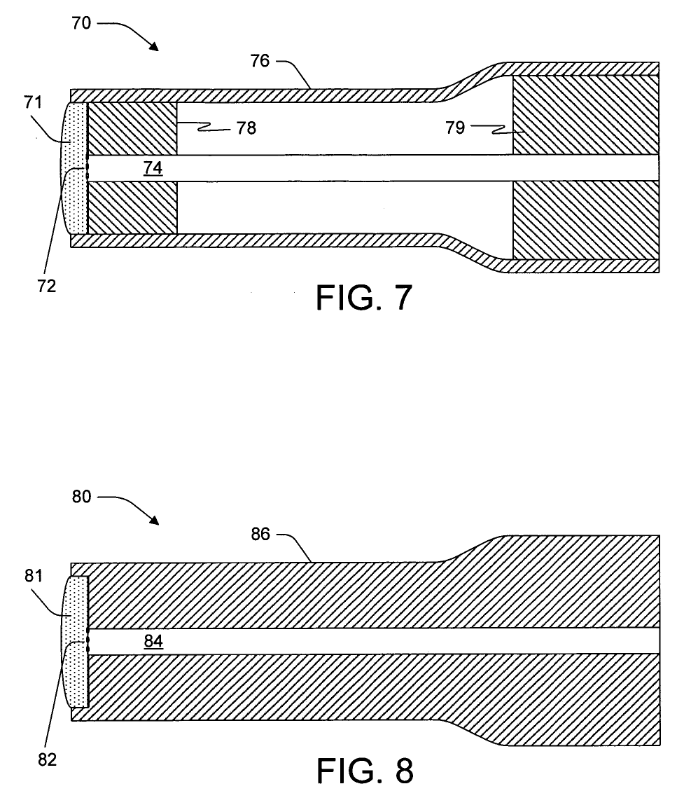

FIG. 7 is a cross sectional view of a sensor element 70 that incorporates an optical fiber 74 having a textured surface 72 at the tip of the distal end thereof. Illustratively the sensor element 70 is shown as a disposable, which mates with a detector (not shown) at the proximal end using any suitable connective technique, such techniques being well known in the art. The optical fiber 74 is held in place by support blocks 78 and 79, which are mounted within a generally cylindrical housing 76. Suitable materials include medical grade plastics, cardboard, metals, and so forth. A body fluid sample 71 is shown at the distal end of the sensor element 70. Illustratively, the diameter of the optical fiber 74 may be 250 μm, the diameter of block 78 may be 1000 μm, the amount of recess of the distal end of the optical fiber 74 from the distal end of the housing 76 may be 100 μm, and the volume of body fluid sample 71 may be 0.1 μl.

A great many variations of the sensor element 70 are possible. In an illustrative variation 80 shown in FIG. 8, a single body 86 may act as both housing and support block. The body 86 is provided with a channel formed along the longitudinal axis thereof to receive optical fiber 84 having a textured surface 82 at the distal tip thereof. The body 86 has a cavity of any desired shape formed at the distal end thereof to receive a body fluid sample 81.

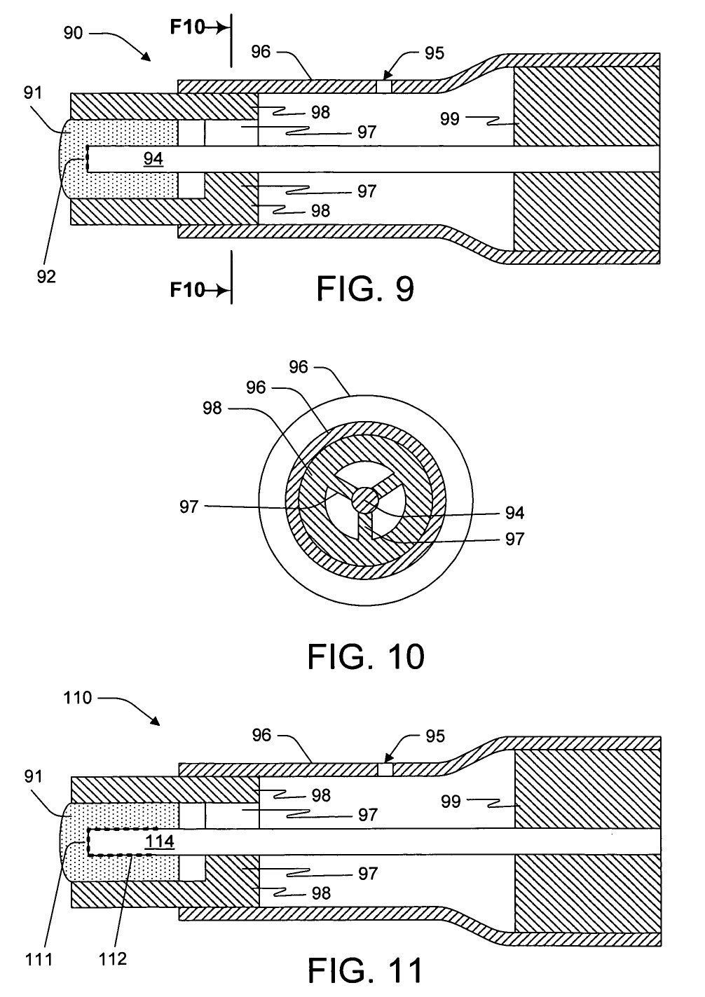

FIG. 9 is a cross sectional view of a sensor element 90 that incorporates an optical fiber 94 having a textured surface 92 at the tip of the distal end thereof. Illustratively the sensor element 90 is shown as a disposable, which mates with a detector (not shown) at the proximal end using any suitable connective technique, such techniques being well known in the art. The optical fiber 94 is held in place by support blocks 98 and 99, which are mounted within a generally cylindrical housing 96. The support block 98 is generally cylindrical and forms a capillary space between the inner wall thereof and the outer cladding of the optical fiber 94. The support block 98 has projections 97 that extend from the inner cylindrical wall to engage and stabilize the optical fiber 94 while preserving fluid continuity between the capillary space and the inside of the sensor element 90, as can be seen more clearly in the cross-section view of the sensor element 90 shown in FIG. 10, which is taken normal to the axis. The inside of the sensor body 90 is vented to the ambient through hole 95, so that a body fluid sample 91 is drawn into the capillary space while remaining distributed across the textured surface 92. Illustratively, the diameter of the optical fiber 74 may be 250 μm, the inside diameter of the support 98 may be 500 μm, the amount of recess of the distal end of the optical fiber 94 from the distal end of the support block 98 may be 100 μm, and the volume of body fluid sample 91 may be 0.2 μm.

A great many variations of the sensor element 90 are possible. In an illustrative variation 110 shown in FIG. 11, an optical fiber 114 is provided with a textured surface at the distal periphery thereof, including the tip 111 and a circumferential sidewall area 112 adjacent to the tip. This arrangement is particularly useful where the analyte is in low concentration so that a greater surface area is need for a sufficient number of binding pairs to form within the specified time of the assay.

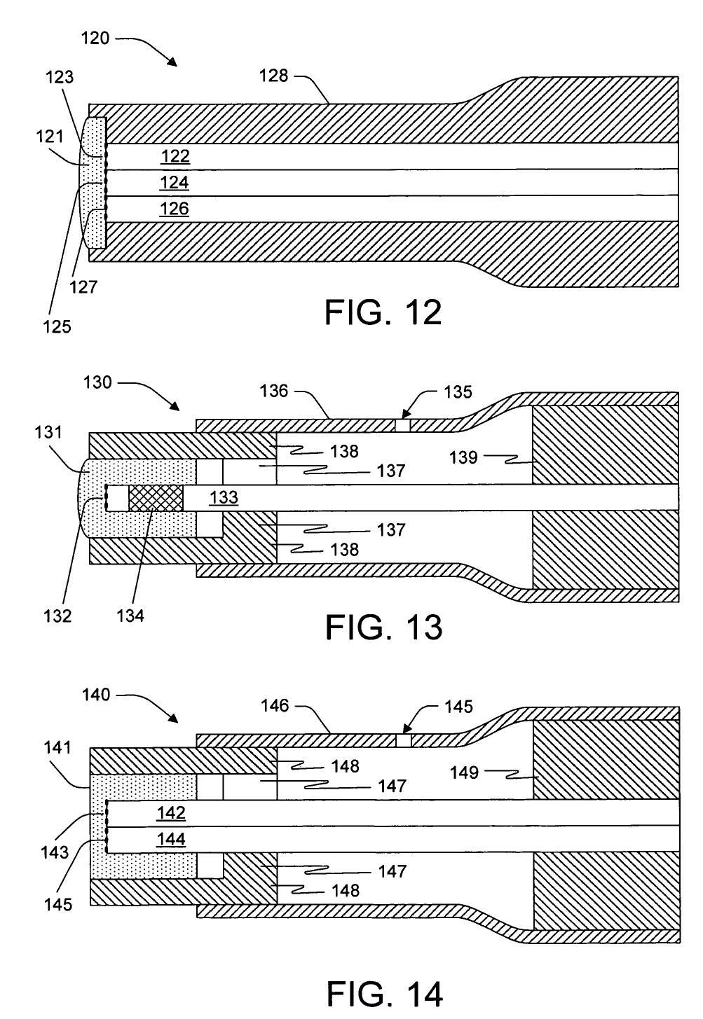

FIG. 12 is a cross sectional view of a sensor element 120 that incorporates a bundle of optical fibers for multiple assays, fibers 122, 124 and 126 being representative. A body 128 is provided with a channel formed along the longitudinal axis thereof to receive the optical fibers 122, 124 and 126, which have respective textured surfaces 123, 125 and 127 at the distal tips thereof. The body 128 has a cavity of any desired shape formed at the distal end thereof to receive a body fluid sample 121. Each of the optical fibers 122, 124 and 126 may perform a different assay.

FIG. 13 is a cross sectional view of a sensor element 130 that incorporates an optical fiber 133 having two textured surfaces 132 and 134 at the distal periphery thereof for two assays. The textured surface 132 is at the tip and the textured surface 134 is around the circumference of the optical fiber 133 in an area spaced slightly apart from the tip. Two different assays may be performed at the textured surfaces 132 and 134. The optical fiber 133 is held in place by support blocks 138 and 139, which are mounted within a generally cylindrical housing 136. A capillary space is provided between the inner wall of the support block 138 and the optical fiber 133. The support block 138 has projections 137. The inside of the sensor body 130 is vented to the ambient through hole 135.

FIG. 14 is a cross sectional view of a sensor element 140 that incorporates multiple optical fibers, optical fibers 142 and 144 being representative, with respective textured surfaces 143 and 145 at the tips thereof. The optical fibers 142 and 144 are held in place by support blocks 148 and 149, which are mounted within a generally cylindrical housing 146. A capillary space is provided between the inner wall of the support block 148 and the optical fibers 142 and 144. The support block 148 has projections 147. The inside of the sensor body 140 is vented to the ambient through hole 145. If an assay should require greater sensitivity, the optical fiber for that assay may be provided with a textured surface at the distal periphery thereof, including the tip and a circumferential sidewall area contiguous to the tip.

While the sensor element embodiments of FIG. 7 through FIG. 14 are shown as having generally cylindrical housings, the sensor elements may have any desired shape such as, for example, oval and flat.

The body fluid may be applied to the various sensor element embodiments described herein in various ways. With respect to the embodiments of FIG. 7 through FIG. 14, for example, one way is to apply the sensor element tip to a small bead of the body fluid. Where the body fluid is blood, the small bead may be obtained by piercing the skin with a small diameter lancet and then milking the wound to obtain a small bead of blood. Alternatively, the housing may be extended to form a thin hollow needle that may be inserted into the body to draw body fluid into contact with the sensor element tip. Yet another arrangement is an integrated lancet/sensor configuration. Given that the sensing element can be made exceeding small in cross sectional geometry, say on the order of 100 microns, the sensing tip may provide the dual purpose of making a minimally invasive puncture as well sensing the analyte of interest. The puncture depth may be controlled in the mechanical design such that the depth interacts with, for example, only interstitial fluid at a puncture depth on the order of 50 microns. Similarly, the puncture depth may be controlled in the mechanical design such that the depth penetrates into capillary bed, if contact with blood is desired. In both cases the small cross sectional puncture area and shallow depth allow for a painless and bloodless procedure for the patient.

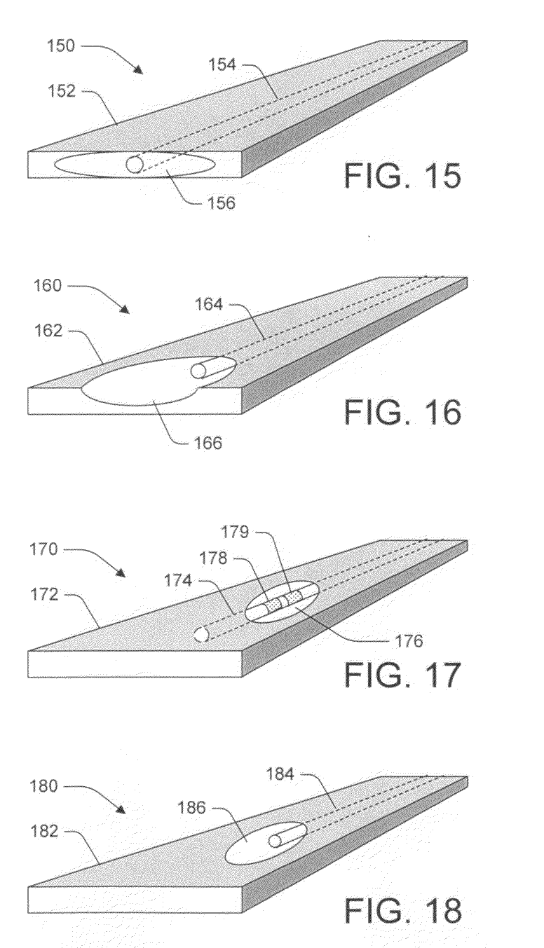

Examples of flat strips that have a superficial similarity to flat diagnostic test strips in common everyday use are shown in FIG. 15 through FIG. 18. FIG. 15 is a perspective view of a strip-like sensor element 150 made of a body 152 that has a cavity 166 provided in the distal end of the body 152. The body 152 is made in any desired manner, such as by molding or by lamination. An optical fiber 154 is embedded in the body 152, and has a surface-textured distal end opening into the cavity 156. The end of the strip 150 is touched to the body fluid sample, which enters the cavity 156 and coats the surface-textured distal end of the optical fiber 154.

FIG. 16 is a perspective view of a strip-like sensor element 160 made of a body 162 that has a cavity 166 provided in the top that extends to the distal end of the body 162. An optical fiber 164 is embedded in the body 162, and has a surface-textured distal end opening into the cavity 166. The end of the strip 160 is touched to the body fluid sample, which enters the cavity 166 and coats the surface-textured distal end of the optical fiber 164. If greater sensitivity is desired, the distal tip of the optical fiber 164 may be angled at other than 90 degrees to the fiber axis, or the optical fiber 164 may be provided with a circumferential sidewall surface-textured area contiguous to the tip. Multiple assays may be done by providing one or more circumferential sidewall surface-textured areas spaced away from the tip and from one another.

FIG. 17 is a perspective view of a sensor element 170 made of a body 172 that has a cavity 176 provided in the top thereof. An optical fiber 174 is embedded in the body 172, and has a portion thereof exposed in the cavity 176. The strip 170 is exposed to the body fluid sample in the area of the cavity 176, and the body fluid sample enters the cavity 176 and coats the surface-textured areas 178 and 179. Areas 178 and 179 are provided for multiple assays, although only a single area may be used if only a single assay is desired, or an extended single area may be used if greater sensitivity is desired.

FIG. 18 is a perspective view of a strip-like sensor element 180 made of a body 182 that has a cavity 186 provided in the top thereof. An optical fiber 184 is embedded in the body 182, and has a surface-textured distal tip opening into the cavity 186. The strip 180 is exposed to the body fluid sample in the area of the cavity 186, and the body fluid sample enters the cavity 186 and coats the surface-textured distal tip. If greater sensitivity is desired, the distal tip of the optical fiber 184 may be angled at other than 90 degrees to the fiber axis, or the optical fiber 184 may be provided with a circumferential sidewall surface-textured area contiguous to the tip. Multiple assays may be done by providing one or more circumferential sidewall surface-textured areas spaced away from the tip and from one another.

In the embodiments described herein that have multiple surface-textured areas for multiple assays, the multiple surface textured areas are shown as being physically separated in various ways. While this minimizes the risk of the chemistry of one assay contaminating the chemistry of another assay, the physical separation is not needed where the assays are completed before the various analytes or the chemical agents have any opportunity to mix.

Another type of sensor element is made from a sheet of transparent optical material such as, for example, plastic, glass, and quartz glass. If well defined sample receiving areas are desired in the sheet, they may be formed by any of various process depending on the type of optical material. Where the material is quartz, for example, the sample areas may be etched using dry or wet etch processes. Opaque coatings may be used where necessary on the surface of the sheet to block ambient light.

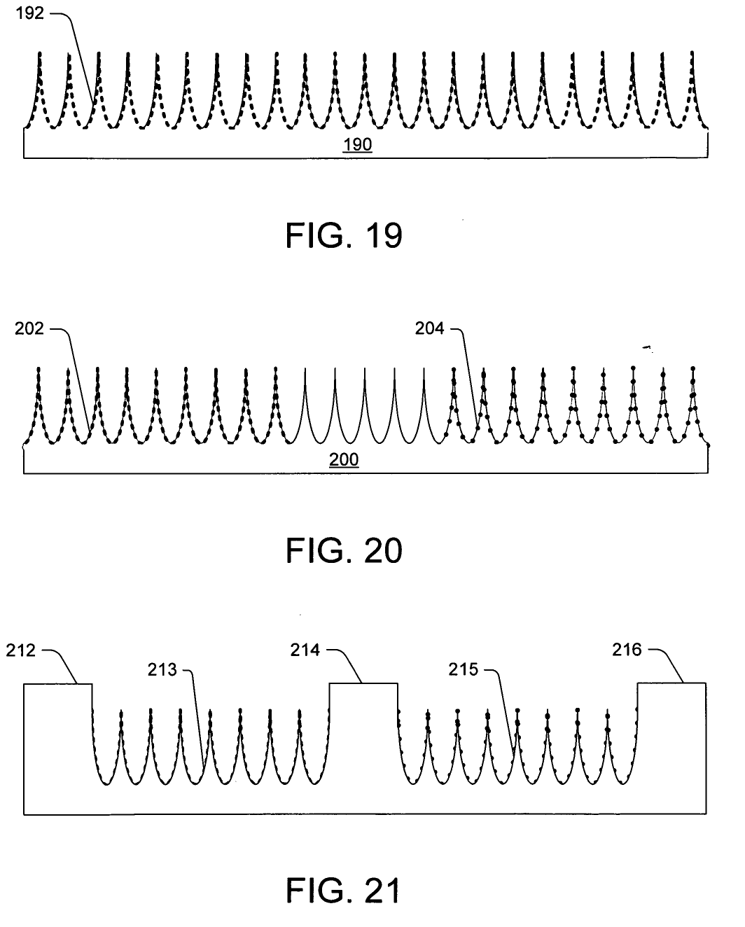

A cross sectional view through a surface textured part 190 of a plastic sheet is shown in FIG. 19. In this embodiment, illustratively a single analyte-specific chemistry 192 is resident upon the textured surface.

FIG. 20 is a cross sectional view through a surface textured part 200 of a plastic sheet. In this embodiment, illustratively two analyte-specific chemistries 202 and 204 are resident upon the textured surface.

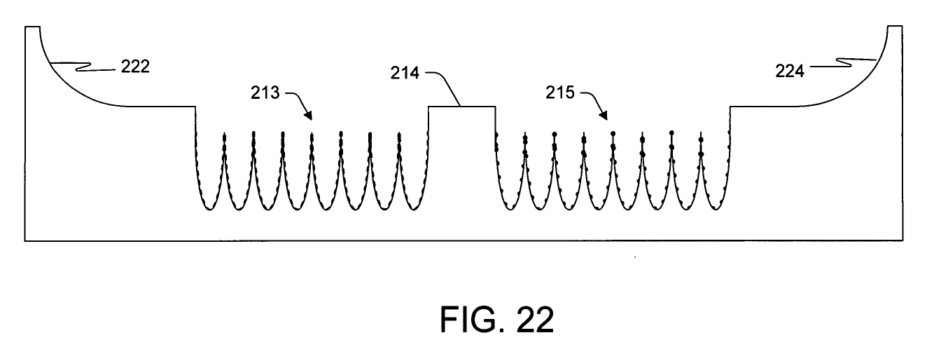

FIG. 21 is a cross sectional view through a part 210 of a plastic sheet that has two surface textured areas separated by a divider 214. In this embodiment, illustratively two analyte-specific chemistries 213 and 215 are resident upon the textured surfaces. FIG. 22 shows the part 210 as being within a well having sidewalls 222 and 224, the well being for receiving a body fluid sample.

It will be appreciated that lens may be formed as parts of the optical sheets.

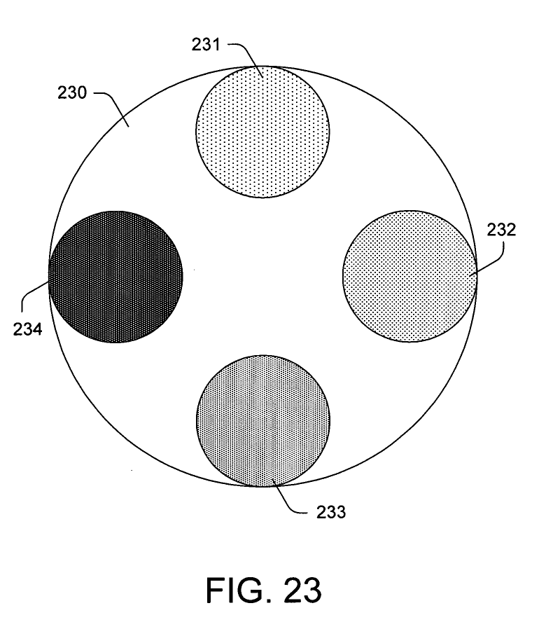

FIG. 23 is a top plan view of a circular sheet of optical material 230 that illustratively has four measurement sites 231, 232, 233 and 234. This embodiment is particularly suitable for use in the instrument shown in FIG. 3, insofar as it may be used at home or in a physician's office to measure several characteristics of a body fluid, such as may be used by person at high risk for heart attack for monitoring glucose levels, total and HDL cholesterol, and various cardiac markers from a single body fluid sample. The four textured surface areas 231, 232, 233 and 234 are treated with different analyte-specific chemistries; for example, area 231 may be treated to measure glucose, area 232 may be treated to measure total cholesterol, area 233 may be treated to measure HDL cholesterol, and area 234 may be treated to measure a cardiac marker.

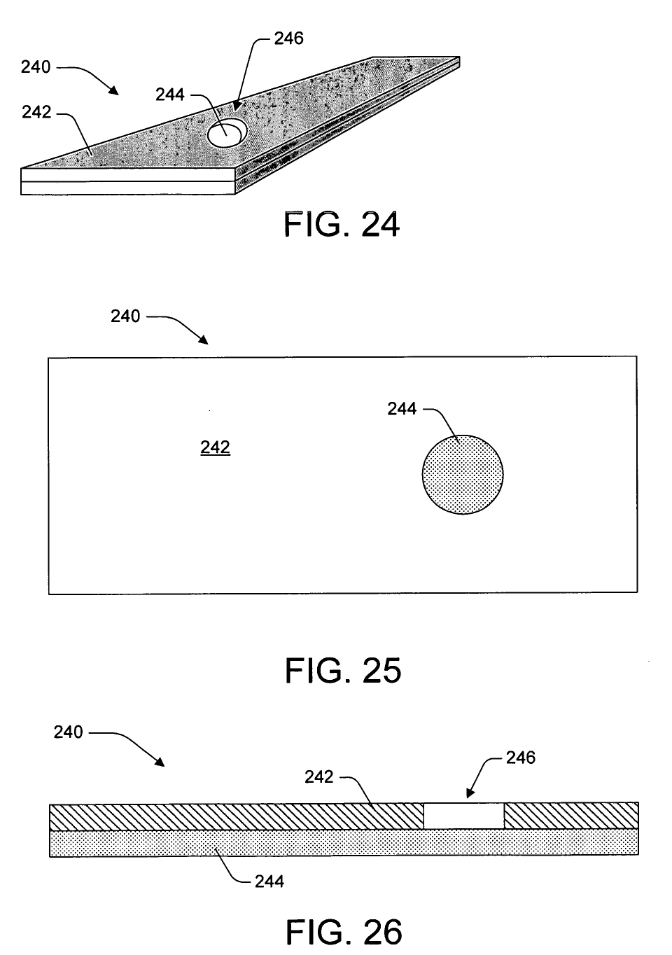

FIG. 24 is a perspective view of an assay strip 240 that incorporates a surface textured optical sheet 244. An opaque cover 242 is securely mounted to the sensor element using any technique suitable for the materials, such as, for example, anodic bonding, heat sealing or fusion, or a light or heat cured adhesive. A hole 246 through the cover 242 admits the body fluid sample. The optical measurement is made from the bottom of the assay strip 240. FIG. 25 is a top plan view of the assay strip of FIG. 24, and FIG. 26 is a longitudinal cross sectional view of the assay strip of FIG. 24.

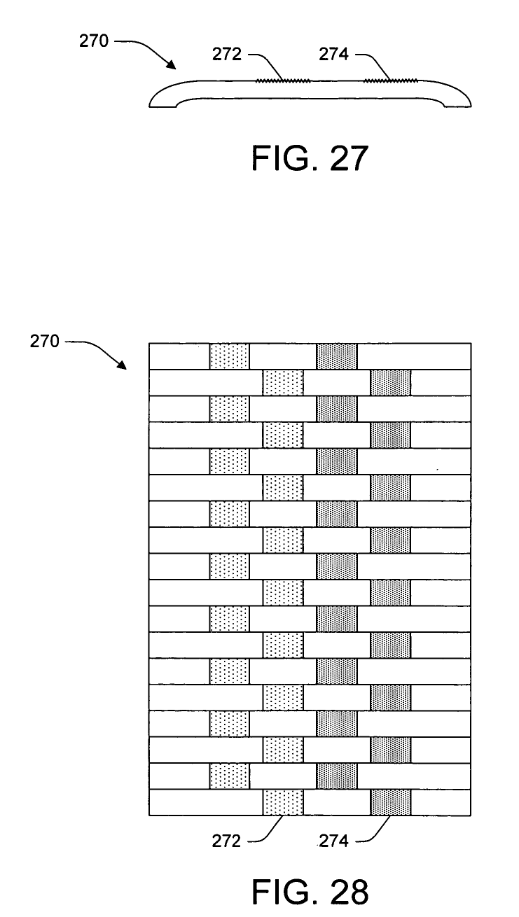

FIG. 27 is a side plan view of a sheet of optical material having curved waveguides therein. The sheet 270 may be made by bending a planar sheet of optical plastic, or by suitably molding optical plastic. Light is introduced into one end of each optical waveguide. FIG. 28, which is a top plan view of the sheet of optical material of FIG. 27, shows 18 such optical waveguides. The waveguides of the sheet 270 may be fabricated in a variety of ways, including etching of slits therebetween and partly through the sheet, filling the spaces with a suitable material for forming reflective surfaces and holding the individual waveguides together, and etching material from the bottom to the materials in the slits to isolate each of the waveguides. Illustratively, multiple measurement sites such as 272 and 274 are formed on each waveguide to make multiple assays using different analyte-specific chemistries, although only a single site may be used on each waveguide if desired.

The Detector

Broadly speaking, the function of the detector or optical subsystem in an assay instrument is to illuminate the analyte-sensitive chemistry when in contact with the body fluid sample under test at a particular wavelength or set of wavelengths, to detect light returned from the analyte-sensitive chemistry, and to calculate one or more characteristics of the body fluid sample based on the detected light. The returned light may be established by the analyte-sensitive chemistry in a variety of different ways, including reflectivity at the optical material interface, evanescent wave effects at the interface, scattering within the analyte-sensitive chemistry and analyte, chemiluminescence or fluorescence of the analyte-sensitive chemistry, or a combination thereof.

One illustrative category of measurement is based on reflectance. In the presence of the analyte under test, the absorption properties of the sample may change at particular wavelengths. As a result, the spectral profiles of light reflected from the sample may look very different for varying test results. One type of test may compare the relative intensities of the reflected light at several predetermined wavelengths, say I1 and I2, and then compare the ratio I2/I1 to a predetermined value. Other tests may be used if desired, such as requiring many more spectral measurements or the use of spectrometers.

Another category of measurements may observe the fluorescence properties of a sample, rather than the absorption properties. When a material fluoresces, it absorbs light at a particular wavelength and reradiates it at a shifted wavelength. Note that the reradiated light need not be part of the illuminating spectrum. The optical system of a test for fluorescence may be similar to that of one that tests for changes in absorption spectrum, and there will be no further distinction between the two types of test in the exemplary embodiments that are presented herein.

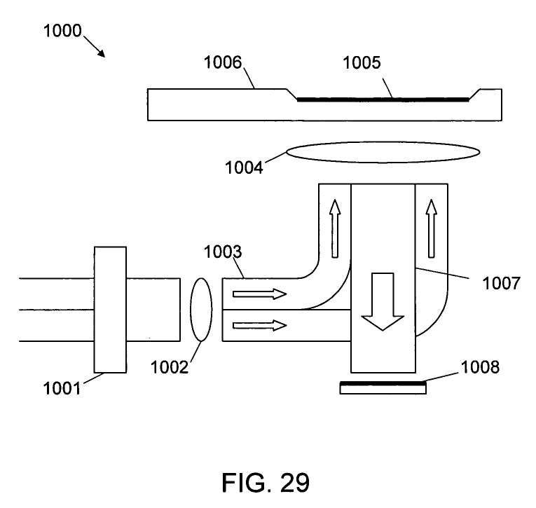

Consider the optical system 1000 of FIG. 29. A light-emitting-diode (LED) 1001 is shown as a light source, although a variety of other light sources may be acceptable, including but not limited to a laser diode, a gas laser, an incandescent or fluorescent bulb, a halogen lamp, or a more complicated light source which scans dynamically over a range of wavelengths. An optional lens 1002 couples light from the source 1001 into at least one illumination fiber 1003. The illumination fiber 1003 may be part of a bundle, similar to the type used in microscope illumination devices. The illumination fiber 1003 transports light from the source 1001 through a lens 1004 toward the planar substrate 1006.

The planar substrate 1006 contains a sample portion 1005, in which the sample under test is placed, say a droplet of blood. Light emerging from the lens 1004 illuminates the sample under test in the sample portion 1005. A fraction of the incident light is either absorbed, having an absorption spectrum coinciding with a reflection test, or is absorbed and reradiated at a longer wavelength, coinciding with a fluorescence test.

A reflected beam of light reflected from the sample, light reradiated by the sample, and light reflected by the planar substrate 1006 that did not interact with the sample, returns through the lens 1004, and enters at least one collection fiber 1007. The collection fiber 1007 may be centrally located in a bundle, surrounded by the illumination fibers 1003. A large number of collection fibers 1007 may be used in the bundle, with the intent of collecting as much reflected light as possible from the sample portion 1005.

Light emerging from the collection fiber 1007 is incident on a detector 1008. The detector 1008 generates a photocurrent in response to incident optical power, and may be a silicon photodetector, for example. The detector 1008 may contain a wavelength-selective coating on one or more surfaces in the detector housing, such as a long-pass filter that transmits wavelengths longer than a particular cutoff, or a notch filter that transmits wavelengths in a particular range. The detector 1008 may also contain a polarization-sensitive element. The detector 1008 may also comprise a beamsplitter and a pair of detectors, where the beamsplitter may have wavelength-sensitive or polarization-sensitive properties. By extension, the detector 1008 may also comprise two or more beamsplitters, with two or more detectors. The detector 1008 may also comprise a more complicated detector device, such as a spectrometer, capable of producing a detailed spectrum at a variety of wavelengths.

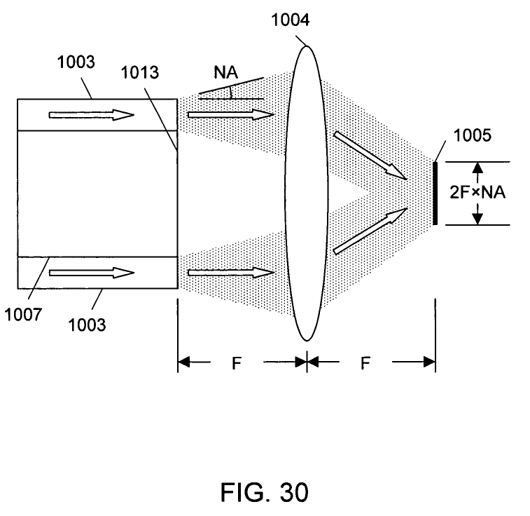

Let us consider more closely the relationship among the fiber bundle, the lens 1004, and the sample portion 1005, shown schematically in FIG. 30. The fiber bundle and sample portion 1005 are placed approximately at the front and rear focal planes of the lens 1004, respectively. The fiber bundle is assumed to be cylindrically symmetric, with the illuminating fibers 1003 surrounding the collection fibers 1007, and with its longitudinal axis roughly coincident with the center of the lens and the center of the sample portion 1005.

Light emerging from the illuminating fibers 1003 appears as roughly uniform illumination at the emergent plane 1013, diverging from the emergent plane 1013 with a divergence given by numerical aperture NA, where NA is the sine of the half-angle of the divergent cone. Assuming that the illuminating fibers are multi-mode, with core and cladding refractive indices of n_{core} and n_{cladding}, respectively, the NA is given by NA=sqrt(n_{core}²−n_{cladding}²). Typical values of NA vary approximately from 0.1 to 0.3 for a multi-mode fiber, depending on wavelength and fiber type.

Because the emergent plane 1013 is placed at the front focal plane of lens 1004, the emergent light appears as collimated after the lens 1004, and the sample portion 1005 receives collimated illumination from a plurality of off-axis angles. Because every location on the sample portion 1005 receives illumination from every location in the emergent plane 1013, the sample is said to be “uniformly illuminated”, which is desirable.

The geometry of FIG. 30 produces a circle of uniform illumination at the sample portion 1005, with a diameter of (2F.times.NA), where F is the focal length of the lens 1004. This relationship is helpful when selecting both the size of the sample portion 1005 and the focal length F of the lens 1004.

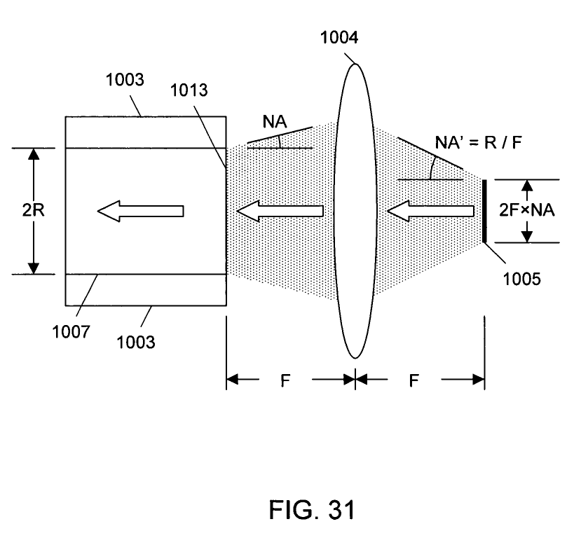

FIG. 31 shows the same geometry of FIG. 30, but with light returning from the sample portion 1005 through the lens 1004 into the collection fiber 1007. We assume that the collection fiber 1007 is actually a collection of fibers centrally located in the bundle, with a diameter of 2R, each of a type identical to the illumination fiber 1003, with characteristic numerical aperture NA.

Light at the sample portion 1005, from the illuminated circle of diameter (2F.times.NA), sends a diffuse reflection back toward the lens 1004. Of note is that the detectable signal is contained in this diffuse reflection, rather than a specular reflection.

A specular reflection is what happens when light hits a mirror. The reflected beam is largely directional, with its direction depending on the angle of incidence on the mirrored surface. In contrast, a diffuse reflection is what happens when light hits a roughened surface, like a piece of paper or a movie screen. The brightness of a reflection from a piece of paper looks roughly the same, regardless of the orientation of the paper. We note that the reflection from the sample portion 1005 is diffuse because the reflecting surface is roughened, although a diffuse reflection is not essential.

The diffuse reflection appears to diverge from the sample portion 1005, and after passage through the lens 1004, appears as a plurality of collimated beams, each characterized by a numerical aperture value less than NA, before entering the collection fiber 1007.

An estimate for the maximum collection efficiency for the geometry of FIGS. 30 and 31 may be calculated as follows. From first-order optics, one finds that the bundle of collection fibers 1007 collects the light reflected from the sample portion 1005 that is emitted into a cone characterized by numerical aperture NA′, where NA′ is the sine of the emergent cone half-angle, and for the geometry of FIGS. 30 and 31 is equal to R/F, where 2R is the diameter of the fiber collection bundle and F is the focal length of the lens. The solid angle subtended by a cone characterized by NA′ is approximately (π×NA′²) steradians (for small values of NA′). From geometrical optics, one finds that a diffuse reflection scatters light roughly uniformly into 2π steradians. A ratio of these two solid angle quantities provides a rough estimate of the maximum collection efficiency of the device, which is found to be NA′²/2. For NA′=0.3, an estimate of the maximum collection efficiency is about 5%.

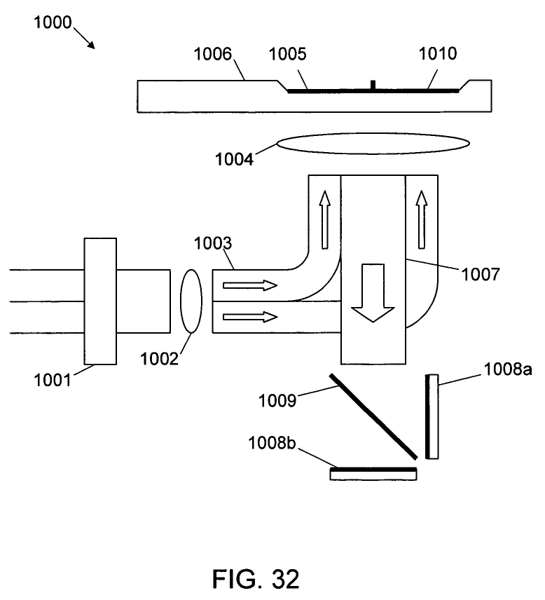

It may be desirable to test for the presence of more than one substance with a single droplet of body fluid. FIG. 32 shows a planar substrate 1006 that contains several sample portions, 1005 and 1010. Each of the sample portions may contain a different analyte-specific chemistry, so that one drop of body fluid may interact with several analyte-specific chemistries, and allow for detection of several body fluid characteristics without drawing additional blood from the patient. The sample portions may be separated by a ridge in the planar substrate 1006, or may be characterized simply by the presence of different analyte-specific chemistries in different locations on the planar substrate 1006. It is understood that although only two sample portions are shown in FIG. 32, more than two sample portions may be used if desired.

The illumination and collection systems of FIG. 32 are identical to those in FIG. 29, and the detection system is modified to accommodate multiple detectors. Typically, at least one detector is used for each sample portion on the planar substrate 1006. After emerging from the collection fiber 1007, the reflected light is split by a beamsplitter 1009 and is detected by a pair of detectors 1008a and 1008b. The beamsplitter 1009 may have wavelength-sensitive properties, reflecting one wavelength band while transmitting another.

It will be appreciated that there should be some measurable difference in the light returning from the multiple sample portions. The differences may result from different spectral properties of the multiple sample portions, different fluorescence properties, and different chemiluminescence properties.

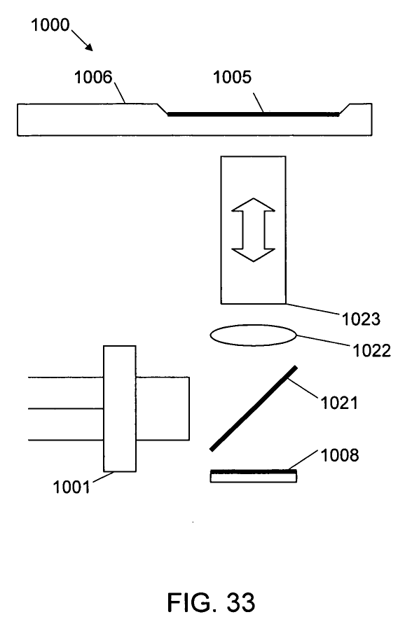

FIG. 33 shows a simpler embodiment of the system in FIG. 29. Light from an LED 1001 is reflected off a beamsplitter 1021, is coupled into a fiber bundle 1023 by a lens 1022, interacts with a sample in sample portion 1005, returns through the fiber bundle 1023, returns through the lens 1022, is transmitted through the beamsplitter 1021, and is detected by a detector 1008.

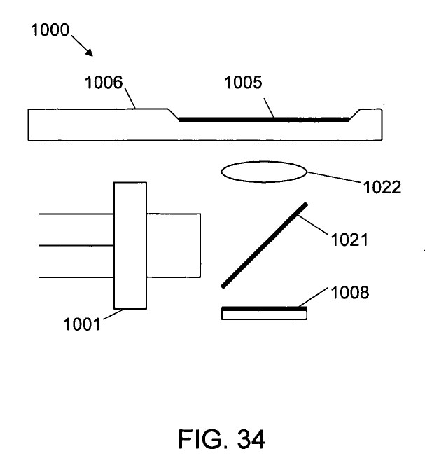

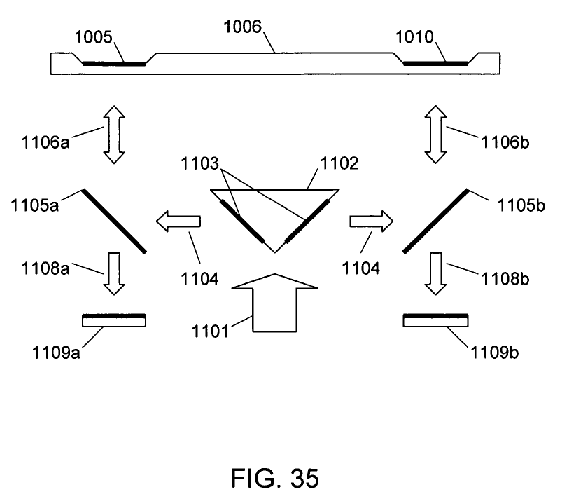

FIG. 34 shows an even simpler embodiment, eliminating the fiber bundle of FIG. 33. Light from an LED 1001 is reflected off a beamsplitter 1021, passes through a lens 1022, interacts with a sample in sample portion 1005, returns through the lens 1022, is transmitted through the beamsplitter 1021, and is detected by a detector 1008.

It should be noted from FIGS. 29, 32, 33 and 34 that the optical systems used to perform the required tests may vary greatly. They generally require a light source, which is capable of providing illumination to the sample portion 1005 at one or more desired wavelengths. A typical light source is an LED. These systems all require a method of delivering the illuminating light to the sample portion. Typical systems may use free space delivery of the light to the sample, in which the light is allowed to propagate freely through space, with no additional components. Other light delivery means may also be used, such as a fiber bundle or an allocated portion of a fiber bundle. These systems all use a method of collecting the light reflected from the sample portion. Again, typical systems may use free space propagation for collection of the light, as well as a fiber bundle or an allocated portion of a fiber bundle. Finally, these optical systems use a method of detecting the reflected light. Typically, photodetectors are used, which convert the incident light into a photocurrent that can be detected by appropriate circuitry. If desired, more complex detection means may be used, including spectrometers, which can provide spectral information in great detail.

FIG. 35 shows an embodiment of an optical system that processes multiple sample portions on the same planar substrate 1006. An incident beam 1101 is strikes a movable reflector 1102. The reflective portions 1103 direct the reflected beams 1104 onto beamsplitters 1105a and 1105b. The beamsplitters 1105a and 1105b may have different characteristics. The reflected beams 1106a and 1106b interact with the sample portions 1005 and 1010, are reflected back through the beamsplitters 1105a and 1105b. The beams 1108a and 1108b that are transmitted through the beamsplitters 1105a and 1105b strike detectors 1109a and 1109b. The movable reflector 1102 may translate or rotate, and may direct the incident beams 1106a and 1106b onto several sample portions on the same planar substrate 1006. The sample portions may contain samples from different patients, or all from the same patient. The portions may also contain same or different analyte-specific chemistries. Although this embodiment is shown with two beams, it will work equally well with any number of beams, including one. This embodiment will work equally well if the movable reflector is removed and one of the other components rotates or translates.

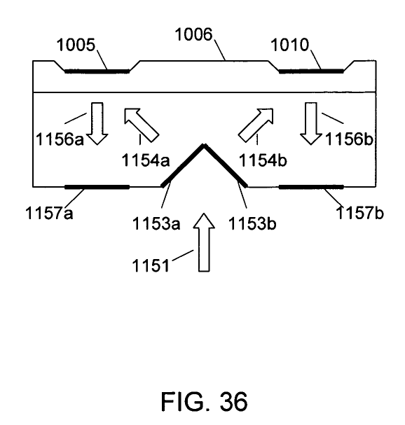

FIG. 36 shows an embodiment in which a stationary element splits the beam into multiple beams, as opposed to the scanning system of FIG. 35. An incident beam 1151 strikes beamsplitter elements 1153a and 1153b, which produces exiting beams 1154a and 1154b. Although the beamsplitter is shown as discrete prism elements, it could equivalently be one or more diffraction gratings, multiple mirrors, or another beam division device. The exiting beams 1154a and 1154b interact with the sample portions 1005 and 1010, are reflected as reflected beams 1156a and 1156b, and are detected by detectors 1157a and 1157b. The detectors may be affixed to a surface.

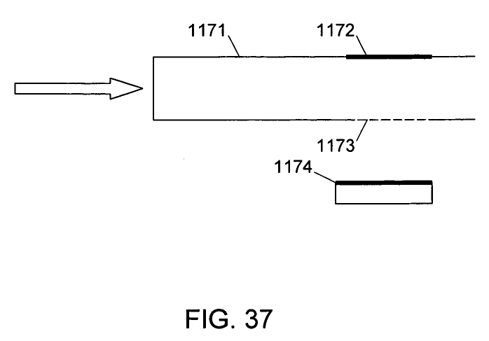

FIG. 37 shows an embodiment in which a sample portion 1172 is located on a waveguide 1171. The waveguide 1171 may be of various shapes including planar and cylindrical. Detector 1174 is located adjacent to the waveguide 1171, outside opening 1173, and receives light reflected from the sample portion 1172. The waveguide 1171 may also be a fiber or fiber bundle.

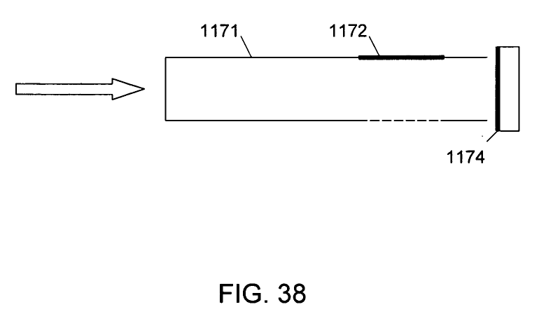

FIG. 38 shows an embodiment in which a sample portion 1172 is located on a waveguide 1171. As opposed to the configuration of FIG. 37, the light that interacts with sample portion 1172 continues down the waveguide 1171 and is detected by detector 1174.

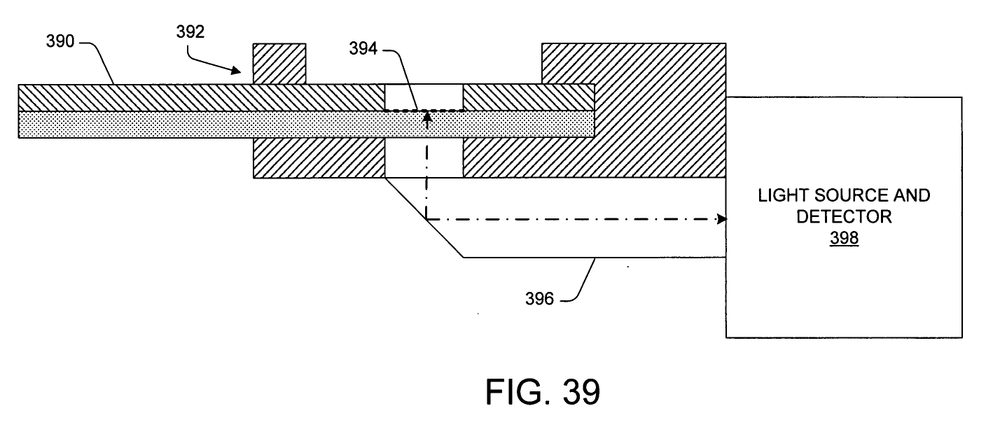

FIG. 39 is a cross sectional view of a slot 392 and optical components for receiving and reading a single site assay strip 390. An optical waveguide 396 guides light between a measurement site 394 and a light source and detector 398.

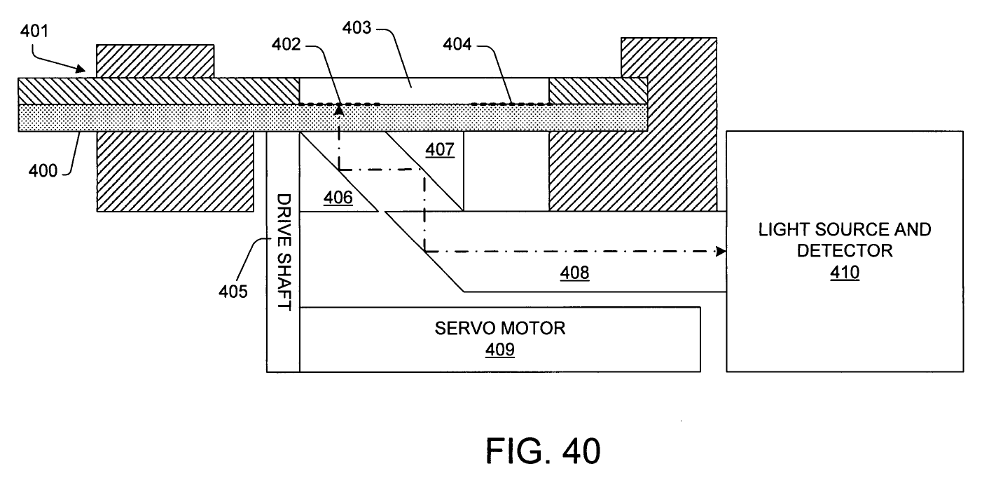

FIG. 40 is a cross sectional view of a slot 401 and optical components for receiving and reading a multiple site assay strip 400. An optical waveguide 409 and mirrors 406 and 407 guide light to and from multiple measurement sites represented by sites 402 and 404 on an optical element 403. In this embodiment, mirrors 406 and 407 are rotated by servo motor 409 via drive shaft 405, and light illumination and light detection is done by a light source and detector 410.

The optical systems described herein may be used with any of the sensor elements described herein. To minimize losses and intrusion of extraneous light between different optical materials, the materials should be firmly urged against one another. If an air gap is allowed to exist, the materials may be treated with an anti-reflection coating, optical elements such as lenses may be used, or the gap may be filled with an index-matching material. Suitable index-matching materials are well known in the art. For embodiments in which the optical material is part of a disposable sensor element, the indexing-matching material may reside on the optical material in its packaged sterile form so that it fills the gap when the disposable sensor element is inserted into the reusable section of the device.

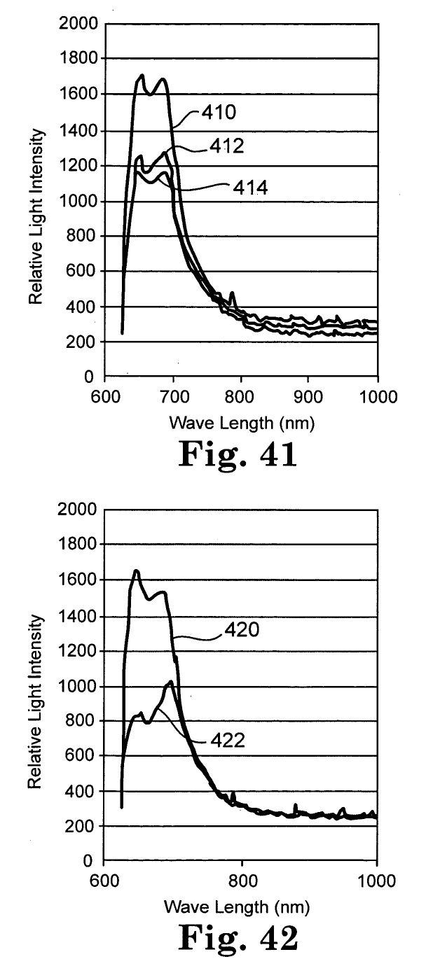

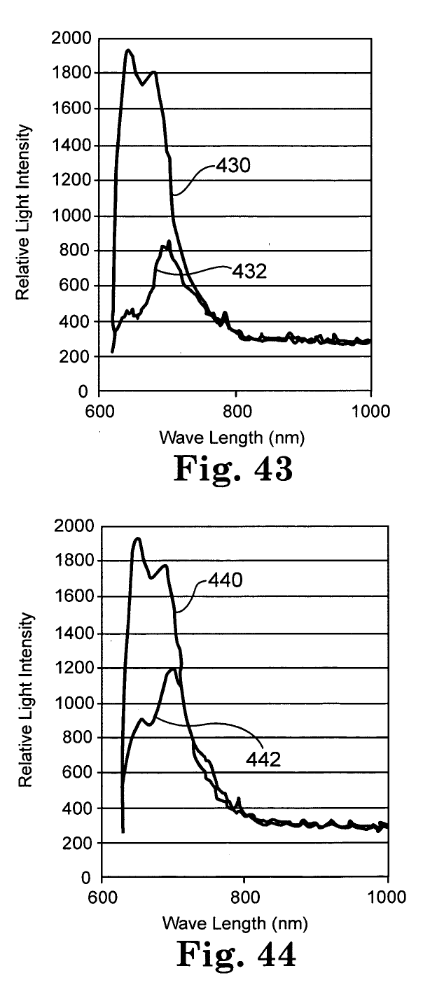

The atomic surface texturing of optical material is believed to improve sensitivity and limit background noise by supporting multiple ray reflections responsive to the light-influencing property of the analyte-sensitive chemistry. FIG. 41 through FIG. 44, which show the effect of surface atomic texturing on the spectroscopic response of an optic fiber pH sensor, are useful for visualizing this effect. Using bromcresol green as a pH indicator, the optic fiber detected pH changes from base to acid by the intensity of reflected light measured by a spectroscopic detector. FIG. 41 is a graph produced with an optical fiber pH sensor that is not textured. Observe the repeatability of pH sensing from base 412 to acid 410, and from acid 410 to base 414. The shift in reflected light intensity between base and acid was strong enough to indicate the pH change. However, greater sensitivity is achieved using an optical fiber pH sensor that is textured. FIG. 42, FIG. 43 and FIG. 44 were created using three textured surfaces (S1, S2 and S3) of differing surface structure achieved by different beam strength during oxygen texturing. Observe that for textured optic fiber tips, the shapes of base spectra 422, 432 and 442 are quite different that the respective shapes of acid spectra 420, 430 and 440, while the shapes of spectra 410, 412 and 414 for the untextured tip are not substantially different. Observe also that at 660 nm, the reflectance light responses between base and acid were much more pronounced for the textured tips, especially between base 432 and acid 430 in FIG. 43.

The description of the invention and its applications as set forth herein is illustrative and is not intended to limit the scope of the invention. The invention in its broad sense is not to be considered as being limited to any particular application or to a specific sensor format, indicator composition, or surface treatment. Variations and modifications of the embodiments disclosed herein are possible, and practical alternatives to and equivalents of the various elements of the embodiments are known to those of ordinary skill in the art. These and other variations and modifications of the embodiments disclosed herein may be made without departing from the scope and spirit of the invention.

1. A sensor element for use in measuring characteristics of a body fluid, comprising:
a supporting body;
an optical material body supported by the supporting body and having a surface-textured area and a light transit area;
an analyte-sensitive chemistry disposed upon the surface-textured area, the analyte-sensitive chemistry having at least one optical property sensitive to binding of an analyte thereto;
a body fluid sample receiving area, the surface-textured area being presented into the body fluid receiving area; and
a light coupling area, the light transit area of the optical material body being presented at the light coupling area;
wherein the surface-textured area comprises a field of projecting elongated optical structures providing an increased effective sensing area and supporting multiple ray reflections responsive to the optical property of the analyte-sensitive chemistry.

2. The sensor element of claim 1 wherein:
the light transit area is a light input area; and
the optical material body further comprises a light output area.

3. The sensor element of claim 1 wherein the light transit area is a light input/output area.

4. The sensor element of claim 1 wherein the optical material body is distinct from the supporting body and attached thereto.

5. The sensor element of claim 1 wherein the supporting body is an extension of the optical material body.

6. The sensor element of claim 1 wherein the optical material body is an optical fiber.

7. The sensor element of claim 6 wherein the supporting body comprises:
a coupling region for removably securing the sensor element to a detector;
an optical coupling region for optically coupling the optical fiber to an optical system in the detector;
a channel disposed within the supporting body, at least a portion of the optical fiber being disposed within the channel; and
a recess at least in part forming the body fluid sample receiving area, the surface-textured area being presented into the recess.

8. The sensor element of claim 6 wherein:
the surface-textured area is disposed upon a first end of the optical fiber in a plane generally normal to light propagation in the optical fiber; and
the first end of the optical fiber is generally even with a surface within the fluid sample receiving area.

9. The sensor element of claim 8 further comprising an additional optical fiber having an additional surface-textured area with an analyte-sensitive chemistry disposed thereon, wherein:
the additional surface-textured area is disposed upon a first end of the additional optical fiber in a plane generally normal to light propagation in the additional optical fiber; and
the first end of the additional optical fiber is generally even with a surface within the fluid sample receiving area.

10. The sensor element of claim 6 wherein:
the optical fiber comprises a first end and a sidewall;
the surface-textured area is disposed upon the first end of the optical fiber in a plane generally normal to direction of light propagation in the optical fiber; and
the first end of the optical fiber and an adjacent portion of the sidewall project into a cavity with the projecting sidewall portion of the optical fiber being spaced away from a sidewall of the cavity to form a capillary space for the body fluid.

11. The sensor element of claim 10 further comprising an additional optical fiber having an additional surface-textured area with an analyte-sensitive chemistry disposed thereon, wherein:
the additional optical fiber comprises a first end and a sidewall;
the additional surface-textured area is disposed upon the first end of the additional optical fiber in a plane generally normal to direction of light propagation in the additional optical fiber; and
the first end of the additional optical fiber and an adjacent portion of the sidewall project into the cavity with the projecting sidewall portion of the additional optical fiber being spaced away from the sidewall of the cavity to form an additional capillary space for the body fluid.

12. The sensor element of claim 6 wherein:
the optical fiber comprises a first end and a sidewall;
a planar reflective surface is disposed upon the first end of the optical fiber in a plane generally normal to direction of light propagation in the optical fiber;
the surface-textured area is disposed upon a portion of the sidewall in proximity to the first end of the optical fiber; and
the first end of the optical fiber and the surface-textured portion of the sidewall project into a cavity with the surface-textured portion of the sidewall being spaced away from a sidewall of the cavity to form a capillary space for the body fluid.

13. The sensor element of claim 12 further comprising an additional optical fiber having an additional surface-textured area with an analyte-sensitive chemistry disposed thereon, wherein:
the additional optical fiber comprises a first end and a sidewall;
a planar reflective surface is disposed upon the first end of the additional optical fiber in a plane generally normal to direction of light propagation in the additional optical fiber;
the surface-textured area is disposed upon a portion of the sidewall of the additional optical fiber in proximity to the first end of the additional optical fiber; and
the first end of the additional optical fiber and the surface-textured portion of the sidewall of the additional optical fiber project into the cavity with the surface-textured portion of the sidewall of the additional optical fiber being spaced away from the sidewall of the cavity to form an additional capillary space for the body fluid.

14. The sensor element of claim 6 wherein:
the optical fiber comprises a first end and a sidewall;
the surface-textured area is partially disposed upon the first end of the optical fiber in a plane generally normal to direction of light propagation in the optical fiber, and partially disposed upon a portion of the sidewall in proximity to the first end of the optical fiber; and
the first end of the optical fiber and the surface-textured portion of the sidewall project into a cavity with the surface-textured portion of the sidewall being spaced away from a sidewall of the cavity to form a capillary space for the body fluid.

15. The sensor element of claim 14 further comprising an additional optical fiber having an additional surface-textured area with an analyte-sensitive chemistry disposed thereon, wherein:
the additional optical fiber comprises a first end and a sidewall;
the additional surface-textured area is partially disposed upon the first end of the additional optical fiber in a plane generally normal to direction of light propagation in the additional optical fiber, and partially disposed upon a portion of the sidewall of the additional optical fiber in proximity to the first end of the additional optical fiber; and
the first end of the additional optical fiber and the surface-textured portion of the sidewall of the additional optical fiber project into the cavity with the surface-textured portion of the sidewall of the additional optical fiber being spaced away from the sidewall of the cavity to form an additional capillary space for the body fluid.

16. The sensor element of claim 15 wherein the analyte-sensitive chemistry of the surface-textured area and the analyte-sensitive chemistry of the additional surface-textured are identical.

17. The sensor element of claim 15 wherein the analyte-sensitive chemistry of the surface-textured area and the analyte-sensitive chemistry of the additional surface-textured are different.

18. The sensor element of claim 6 wherein:
the supporting body is in the form of a test strip; and
the fluid sample receiving area is a sample bowl within the test strip.

19. The sensor element of claim 18 wherein:
the surface-textured area is disposed upon a first end of the optical fiber in a plane generally normal to light propagation in the optical fiber; and
the first end of the optical fiber is generally even with a surface of the sample bowl.

20. The sensor element of claim 18 wherein:
the surface-textured area is disposed upon a first end of the optical fiber in a plane generally normal to light propagation in the optical fiber; and
the first end of the optical fiber extends into the sample bowl.

21. The sensor element of claim 18 wherein:
the optical fiber comprises a first end and a sidewall;
a planar reflective surface is disposed upon the first end of the optical fiber in a plane generally normal to direction of light propagation in the optical fiber;
the surface-textured area is disposed upon a portion of the sidewall; and
the surface-textured area of the sidewall is contained within the sample bowl.

22. The sensor element of claim 1 wherein the optical material body is an optical material sheet.

23. The sensor element of claim 22 wherein:
the supporting body comprises an elongated opaque sheet having an orifice therethrough; and
the optical material body is disposed in the orifice.

24. The sensor element of claim 22 wherein:
the supporting body comprises an elongated opaque sheet having a front side, a back side, and an orifice therethrough; and
the optical material body comprises an elongated sheet having a front side and a back side, the surface-textured area being formed on the front side of the optical material body, and the light transit area being on the back side of the optical material body opposite the surface-textured area;
wherein the surface-textured is aligned with the orifice to form the body fluid receiving area.

25. The sensor element of claim 22 wherein:
the supporting body comprises an elongated opaque sheet having a front side, a back side, and
an orifice therethrough; and the optical material body is disposed in the orifice, the surface-textured area being oriented in common with the front side to form the body fluid receiving area, and the light transit area being oriented in common with the backside to form the light coupling area.

26. The sensor element of claim 1 wherein the optical material body is a waveguide.

27. The sensor element of claim 26 wherein:
the supporting body comprises sidewall portions of the waveguide; and
the surface-textured area is disposed on a sidewall portion of the waveguide.

28. The sensor element of claim 1 wherein the optical material body is a waveguide, further comprising a plurality of additional waveguides integrated with the waveguide, wherein:
the surface-textured area is disposed on a sidewall portion of the waveguide; and
additional surface-textured areas are respectively disposed on the additional waveguides.

29. The sensor element of claim 1 wherein the optical property is reflectance, absorbance, fluorescence, or chemiluminescence.
